(19) United States
(12) Patent Application Publication
(10) Pub. No.: US 2021/0180351 A1
(43) Pub. Date: Jun. 17, 2021

(54) SYSTEM AND METHOD FOR BUILDING FAÇADE CLEANING AND PAINTING WITH A DUAL CABLE-DRIVEN ROBOT

(71) Applicant: Chun Wo Construction & Engineering Co., Limited, Hong Kong (HK)

(72) Inventors: Darwin Tat Ming LAU, Hong Kong (HK); Yuen Shan CHAN, Hong Kong (HK)

(21) Appl. No.: 17/120,302

(22) Filed: Dec. 14, 2020

Related U.S. Application Data
(60) Provisional application No. 62/948,778, filed on Dec. 16, 2019.

(51) Int. Cl. E04G 23/00; B05C 1/08; B25J 11/00; F16M 13/02; B66D 1/60; B66D 1/36

(52) U.S. Cl. CPC E04G 23/002; B05C 1/08; B25J 11/0085; B66D 1/26; B66D 1/605; B66D 1/36; F16M 13/022

(57) ABSTRACT

A robot system for maintenance of a building façade with an irregular façade surface is provided. The robot system includes a platform cooperating with a least four pairs of cables for positioning the platform at a distance from a building façade. At least one robot arm is situated on the platform, and includes an adaptor positioned at a distal end thereof for holding and manipulating a building façade maintenance tool. An actuator drives the cables to move the platform to any arbitrary position along the building façade. A controller cooperates with the actuator to instruct the actuator to drive the cables and to control movement of the robot arm, such that driving the actuator and movement of the robot arm is coordinated by the controller; any position deviations in the platform are compensated for by positioning or movement of the robot arm.

### CROSS-REFERENCE TO RELATED APPLICATIONS

This application claims priority from the U.S. provisional patent application Ser. No. 62/948,778 filed Dec. 16, 2019, and the disclosure of which is incorporated herein by reference in its entirety.

### FIELD OF THE INVENTION

The present invention pertains to a robot system for building façade maintenance operations. More particularly, the robot system includes a platform including one or more robot arms installed on the platform for windows and/or facade cleaning, maintenance, and painting using plural tools.

### BACKGROUND

Exterior façade operations, such as window cleaning and painting, have been identified by the construction industry as expensive and dangerous. For high-rise buildings having over 30 floors, the most common approach is to employ rope or gondola-based systems, either by restraining a worker using ropes/cables or restraining the platform in which the worker(s) stand on to perform the required tasks. Due to the difficulties in entering and leaving the system, the laborers are typically working for extended periods of time. Additionally, at such high working heights, the harsh weather conditions, high heat, wind and rain, also cannot be avoided. Furthermore, cases of accidents, although infrequent, will typically result in either serious injury or death to the workers. These factors have resulted in a lack of skilled workers, increasing worker insurance costs and consequently high labor costs.

To address these concerns, robots have been developed to automate specific façade maintenance operations and replace the more dangerous work performed by humans. Window cleaning robots are amongst the most common that have been developed for exterior façade work. The most common type of robot that is used is a mobile robot, where the mechanism typically either crawls or use wheels to maneuver, and is secured with a safety harness to prevent the robot from falling and injuring pedestrians below. Another type of application for these mobile robots is the painting of large façades. There are two characteristics that must be noted for such existing façade maintenance solutions. First, the methods typically involve spraying of water or paint, or using rolling brushes. These techniques have not been well accepted by the building industry, for their inability to sufficiently clean or paint building surfaces. Second, such mobile robots only operate well on flat, or close to flat, surfaces and struggle on more complex surfaces or when the building façade has any protruding features such as boxed or bay windows or curved glass walls. Non-flat and surfaces with protruding features are common in many high-rise buildings in Hong Kong, particularly those resulting from modern architectural designs. Thus, there is a need for robotic building façade maintenance systems that can accommodate a wide variety of complex architectural features.

### SUMMARY OF THE INVENTION

Recently, the development of dual cable-driven robot systems has been adapted to autonomously perform window cleaning and façade painting/maintenance. Rather than mobile robots, dual cable-driven robots are a special type of parallel robot where multiple cables are used to drive platforms equipped with robot arms. The primary advantage of dual cable-driven robots compared to mobile robots is that robot arms are mounted on a platform that is securely positioned and controlled, Advantageously, a variety of building façade maintenance tasks may be performed by the robot arms.

The inventive system combines the dexterity of robot arms with the dual cable-driven platform's ability to operate over large areas. Furthermore, the robot arms permit cleaning with wipers and painting with rollers in the same manner as human workers, including the ability to operate on surfaces that are not completely flat. Through the use of a system controller, cooperation between the robot arm(s) and the platform may be coordinated so that any positional aberration in the platform (e.g., tilt, distance from the façade surface, etc.) can be compensated for by the robot arms to ensure accurate cleaning or painting.

The present invention pertains to a system comprising a dual cable-driven robot that can be configured to control the position of a working platform. The system also comprises robot arms which can be mounted on top of the working platform. The system is capable of cleaning windows and painting façade. The dual cable-driven robot can be configured to handle different size of building façade. Motors and winches are installed at the ceiling and floor of the façade, which guides and control the cable in which connected to the platform and allows the platform to travel to different position. In one embodiment, the dual cable-driven robot system may be driven by a single motor handling two cables. In this manner, the number of motors necessary to drive the eight cables attached to the platform is reduced, while maintaining the stiffness and increasing the platform stability.

One or more robot arms mounted to the platform perform the motions necessary for building maintenance operations. Since the platform remains close to the façade surface, different motions are performed by the robot arm for cleaning and painting. When multiple robot arms are employed, they cooperate for tasks, which improves the working efficiency increases the ability to perform complex tasks.

The system of the invention can perform end-to-end windows cleaning and façade painting procedures, including a solution-dispensing system (e.g., paint, cleaning fluid) to robot(s) mounted on the dual cable-driven platform. Through computer control and optional feedback through sensors, building maintenance processes can be automated more than conventional methods and require less human intervention. The system of the present invention has good scalability and portability, and can easily adapt to different façade surfaces building sizes and configurations. As compared to mobile robots, the present robot system simulates human cleaning and painting, improve finishing quality and efficiency.

In certain embodiments, the system may include human interactive controls such as joystick or other remote controllers, to control the position of the platform and motion of the robot arm(s) in real time. This is to provide an alternative way to manually control the system when desired.

### BRIEF DESCRIPTION OF THE DRAWINGS

Some embodiments of the present invention are illustrated examples and are not limited by the figures of the accompanying drawings, in which like references may indicate similar elements and in which:

FIG. 1A illustrates a perspective view of one embodiment of the system of the invention, with a dual cable-driven robot system, a moving platform with robot arms, winch systems and actuators.

FIG. 1B illustrates a side view of an upper cable system used with the platform of FIG. 1A.

FIG. 1C illustrates a side view of a lower cable system used with the platform of FIG. 1A.

FIG. 2 shows the end-effector platform design of an embodiment of the dual cable-driven robot system, comprising robot arms, a source of power, cable guiding winch system and other components required for the tasks.

FIG. 3A illustrates a single suspension system for the platform of FIG. 1A. The system includes an overhang beam and set of pulleys. FIG. 3B illustrates a cable guiding system for the platform of FIG. 1A. The system comprises pulleys that used to guide the cable at the floor level.

FIG. 4 illustrates a cable actuating unit for the system of FIG. 1.

FIG. 5A illustrates a robot arm with window wiper mounted at the tip. FIG. 5B is an enlarged view of the end of the robot arm of FIG. 5A.

FIG. 6A illustrates a robot arm with a sponge roller tool. FIG. 6B is an enlarged view of the end of the robot arm of FIG. 6A.

FIG. 7A illustrates a robot arm with a paint roller mounted at the tip. FIG. 7B is an enlarged view of the end of the robot arm of FIG. 7A.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “am,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not prelude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Dual cable-driven robot system, apparatuses, and methods for windows cleaning and façade painting in 3D space are disclosed herein. In the following description, for purposes of explanation, numerous specific details are set forth to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or the description below.

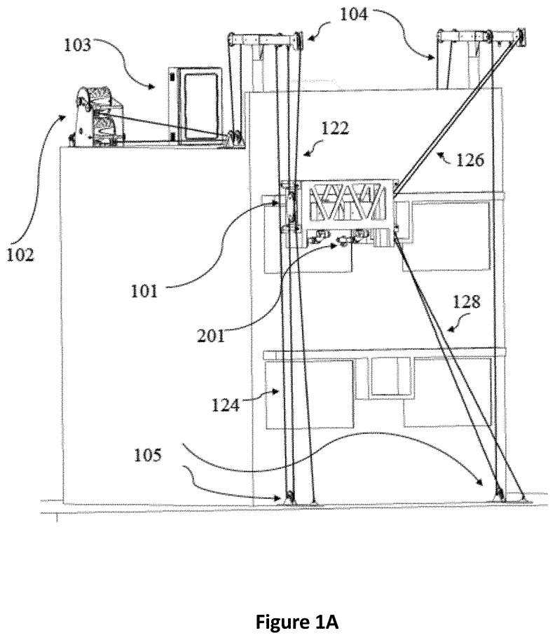

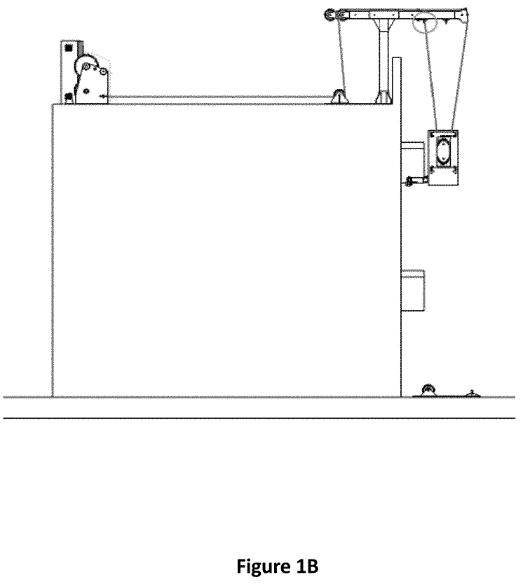

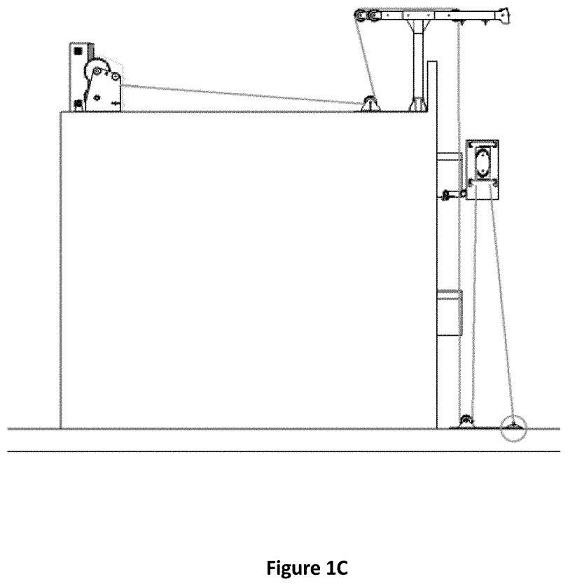

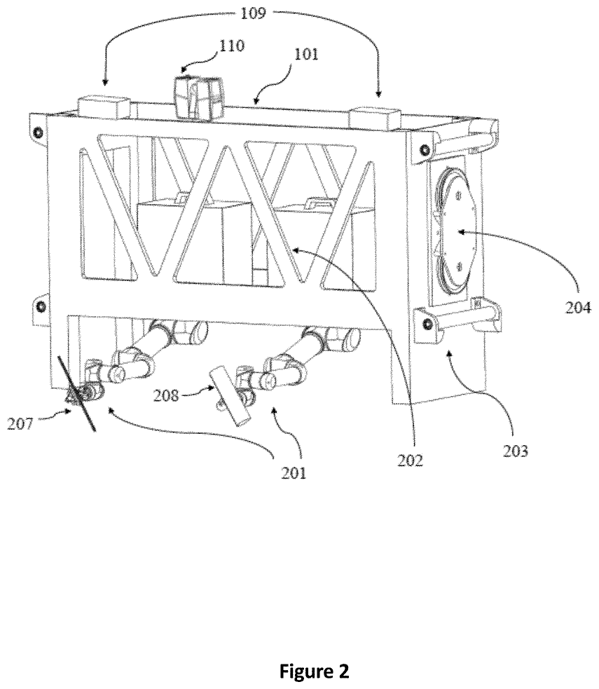

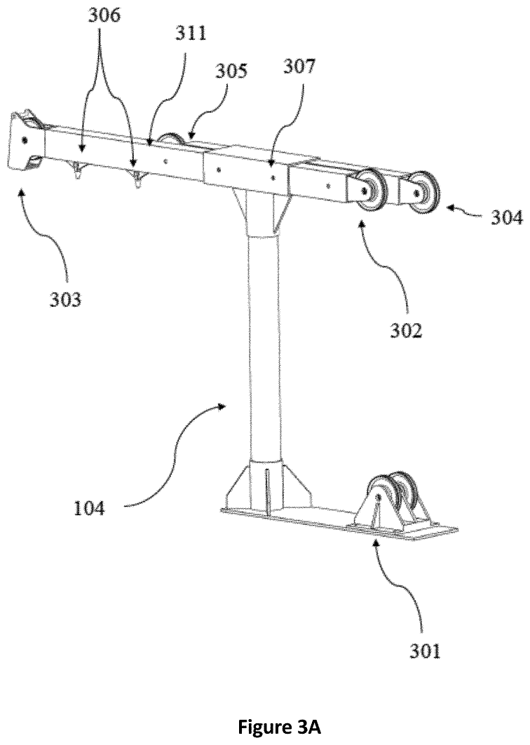

The present invention will now be described by referencing the appended figures representing preferred embodiments. FIG. 1A depicts an isometric view of the system for building maintenance such as window cleaning and façade painting using a dual cable-driven platform with one or more robot arms. The dual cable robot system includes an end-effector platform 101, cable winch and actuating unit 102, system controller, tool changer and consumable refilling station 103 and cable routing suspension systems 104, 105. One or more robot arms 201 are mounted to platform 101.

As seen in FIG. 1A, the cable routing systems 104 and 105 may be mounted at fixed points on the building or at points adjacent to the building (e.g., lower cable routing system 105 may be mounted permanently or temporarily on the ground in front of the building). The dual cable robot system of the present invention includes independently-drivable cable pairs 122, 124, 126, and 128 that used to control the position and tilt of platform 101 by varying the cable length through actuating unit 102. The term “dual cable” is defined as there are four pairs for a total of eight cables controlling the position of platform 101; each set of cables is controlled as a pair. Each cable pair has one end fixed at position 104 or 105, with the other end connected to the actuator 102. Note that while a single actuator 102 is depicted, plural actuators may also be used. A pulley system 204 (to be described in more detail below) on the platform 101 enables the platform to be stably positioned by the dual cable configuration. Importantly, by providing a system of four pairs of cables, the positioning may be precisely controlled such that the system can be employed on buildings with irregular facades, for example, boxed windows, bay windows, curved surfaces, and architectural features.

To assist with the correct positioning of platform 101 and robot arm(s) 201, plural positional sensors 109 and/or machine vision elements 110 may be positioned along the platform periphery (e.g., the leading edges of the platform) and on the robot arms. Feedback from the sensors/machine vision elements is used to determine the attitude of the platform (e.g., platform tilt) and can be fed to a system controller.

Unit 103 may include a variety of system elements including the system controller along with optional a consumable material reservoir/refilling station and optional tool changing station. The motion of the dual cable actuator 102 is controlled by the system controller in unit 103, which is responsible for calculating the corresponding cable movement and required cable lengths to drive the platform 101 to the desired work area. Importantly, the controller coordinates the motion of both the robot arm(s) and the platform, optionally in connection with the sensors described above. Through the coordination of platform/robot arm movement, any positional aberration in the platform (e.g., tilt, distance from the façade surface, etc.) can be compensated for by the robot arm to ensure accurate cleaning or painting.

In one aspect, the optional sensors 109 and 110 may be used to map the building façade features prior to performing building maintenance operations. By mapping the façade features, the system controller may calculate the trajectory of platform 101 and the position of robot arm(s) 201. Machine vision elements can determine the position of glass surfaces for window cleaning, and walls for façade cleaning, calculating a path for window cleaning with a window-cleaning tool followed by a path for façade cleaning with a façade-cleaning tool. In this manner, the most efficient path can be calculated for the various maintenance functions to be performed, minimizing the number of tool changes/fluid changes that are needed to perform multiple functions.

Tool changing can be performed in an automatic or semi-automatic fashion with a commercial or custom-built tool changing station in unit 103. Alternatively, a tool-changing station may be included on platform 101 to minimize the distance that platform 101 must travel. Similarly, a material reservoir may be included on platform 101 to minimize the distance needed to supply cleaning or painting material to the vicinity of the robot arm(s).

The dual cable robot system works in a planar workspace and the cable configurations can be viewed as upper and lower sections. The upper cable routing is schematically illustrated in FIG. 1B and the lower cable routing is schematically illustrated in FIG. 1C, in which the cable fixture points are circled. The pulley systems 104, 105 accommodate the dual cable configuration.

Turning to FIG. 2, an enlarged view of platform 101 and robot arms 201 is depicted. The end-effector, dual cable robot gondola-based working platform 101 includes robot arm(s) 201 with tools 207, 208, power and consumable supply system 202, cable routing system 203 and 204. The platform 101 may optionally include a bumper and roller that avoid the platform from accidentally colliding to with building surface.

The robot arm 201 may be selected from any type of programmable mechanical arm that typically includes various links coupled together with joints that permit rotational or translational movement. At the distal end of the robot is an end effector for holding and manipulating a tool. The robot arm is selected based on a desired number of degrees of freedom. A degree of freedom is a mode of motion for the robot arm. The total number of degrees of freedom define the ability of the robot arm to access any location at an arbitrary angle within a three-dimensional volume. For example, the human arm has at least six degrees of freedom, meaning that it can move forward and backward, up and down, left and right including changes in orientation and rotation in a 3D volume. Typically, the robot arm(s) of the present invention are selected to have at least 6 degrees of freedom such that it can replicate the motion of the human arm. Additional degrees of freedom permit the robot to perform the same task from different positions and may be selected depending upon the types of building maintenance to be performed.

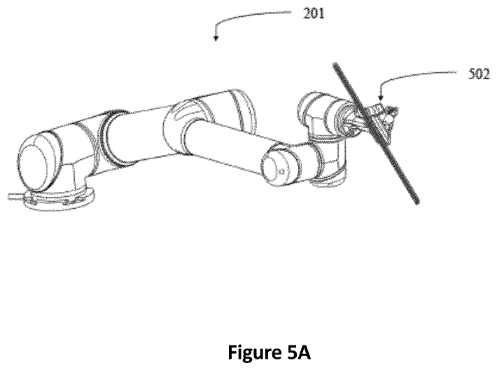

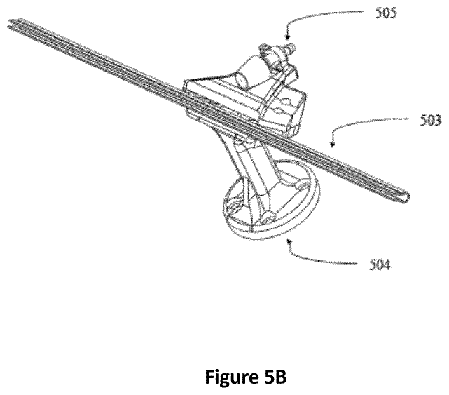

Robot arm 201 is responsible for the complicated human-like motion which is required for a building maintenance task. For example, for cleaning applications, one robot arm may carry a window wiper 503 (see FIG. 5A) and another arm may carry a sponge for moistening the window surface and absorbing extra water droplets during the wiping motion. Also, for façade painting applications, the robot arm 201 performs paint application using a paint roller tool and liquid paint feeding system.

An optional power and consumable supply system 202 supplies the power to drive the robot arm(s) and all on-board electrical components (e.g., optional sensors and cameras). It may include a reservoir for holding water and detergent for façade cleaning and paint for façade painting. Inspection tools or work tools can also be mounted, including tool changer carousels, and obtain electricity from the supply system 202. Alternatively, the power and consumable supply system may be located remotely, either on the ground or the roof, with electrical cables and liquid supply cables extending to the robot arms from the remote supply system.

In order to accommodate the four pairs of cables, pulley system 203 and 204 is provided. Pulleys 204 are used for the platform 101 rolling and moving from all 4 cables. Roller 203 is used to guide the cable from entering the pulleys 204 when the platform is at different positions.

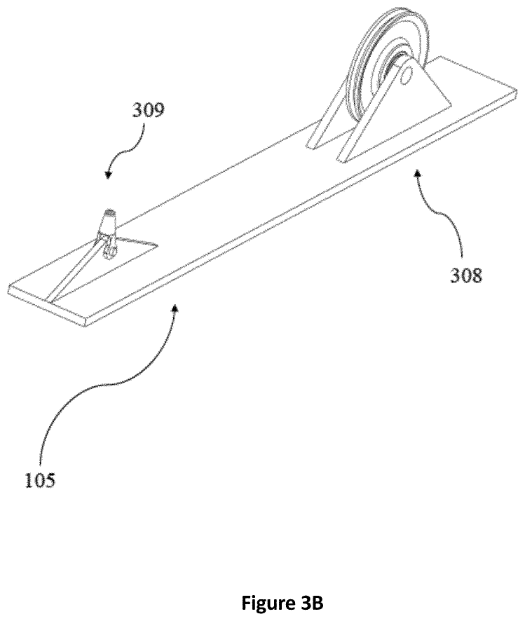

Turning to FIG. 3A, a winch and pulley system 300 is depicted. System 300 can route both upper and lower pairs of cables. System 300 positions the end-effector platform 101 at a distance from the building façade by adjusting the cable suspension system and the location of the fixed end. The actual adaptation of dual cable robot system depends on actual building design and working environment, where the winch systems may vary, as well as different locations of the driving motor. To assist in maintaining the position of platform 101 an optional spacer arm(s) may be positioned extending between the platform to the building façade. The spacer arm(s) may be equipped with sensor to assist in mapping the building façade and optional cameras so that a human operator may inspect the building façade and the work performed by the robot arms 201. A spacer arm may also be positioned extending from a side of the platform 101 in order to sense approaching projections from the building façade.

The cable routing suspension system 104 in FIG. 3A can be divided into a cable pulley system and a suspension system. In the embodiment of FIG. 3A, a single suspension system can route two cables to travel. A cable 122 (FIG. 1) attached to the top corner of platform 101 will pass through the left channel of pulley 301, then route to pulley 302, followed by pulley 303. From pulley 303, the cable 122 will pass through the upper pulley of platform pulley 204 (FIG. 2) and travel back to cable fixture 306. The side view of the upper cable routing is shown in FIG. 1B. The cable 124, attached at the lower corner of platform 101, will pass through the right channel of pulley 301, to pulley 304, through pulley 305. From pulley 305, the cable 124 travels to pulley 308 (FIG. 3B) which may be mounted on the ground or on the base of the building, through the lower pulley of platform pulley 204 to the cable fixture 309 (FIG. 3B). The side view of the lower cable routing is shown in FIG. 1C. Note that additional cables can be routed by system 104 when additional pulleys are provided. Because the cable routing suspension system 104 is able to adapt to different building façade configurations with various arbitrary protruding elements, the length of the suspension system 311 arm can be adjusted by screws at 307.

As shown in FIG. 1, the actuating units 102 are installed at the roof level of the targeted building; however, at the ground level, there is only passive pulley system as seen in FIG. 3B, which contains a pulley 308 for translating the cable from roof to the platform 101, and a cable fixture point for lower cable. Alternatively, the system may be configured such that the actuating units 102 are provided at the ground level, for example, if the actuators are portable units that are brought to the building site for the period of building maintenance.

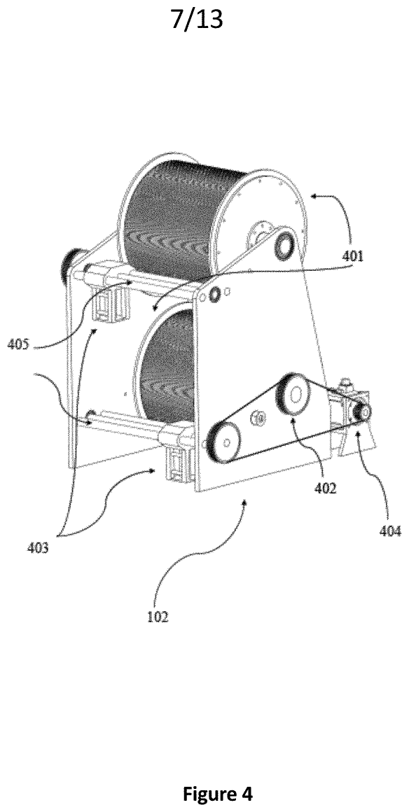

Turning to FIG. 4, the cable winch and actuator unit 102 is responsible for controlling the cable pairs, moving end-effector platform 101 to any desired position along the building facade. FIG. 4 shows a compact design of the unit, where two sets of actuators are situated together to drive both cable pairs 122 and 124. Winch 401 is used to accumulate cable, and it is driven by a motor 404 using the belt system 402. The belt is also connected to a cable outlet 403, which will travel along the linear rail 405 and guide the cable to towards cable winch 401in a controlled manner. Motor 404 receives a drive signal from controller 103 and drives the winch for controlling the cable length as a result, thus controlling the motion of platform 101.

As building façades will have a large variety of different architectural features (protruding elements, curved surfaces, air conditioners or other mechanical systems), the non-flat façade makes the cleaning or painting motion much difficult and difficult for automation. In the system of the present invention, the suspension mechanism causes the platform 101 to be maintained at a sufficient distance from the building façade to avoid various protruding elements. Consequently, robot arm(s) 201 is configured to reach the surface to be cleaned or painted according to the shape of the façade while the platform 101 is driven. In addition to the length of the robot arm itself the robot arm may extend to reach of the tool through extension rods in order to expand the reach an additional meter or more.

Turning to FIG. 5A, a close-up of robot arm 201 is depicted, along with a tool for window cleaning. The robot arm includes six degrees of freedom; however, other numbers of degrees of freedom may also be used. A wiper system 502 is mounted at the distal end of robot arm 201. The wiper system 502 is specially designed for the dual cable robot system; as shown in FIG. 5B, it includes at least three major components: the cleaning blade 503, a wiper-robot arm adaptor 504, and cleaning fluid dispensing system 505. The cleaning blade 503 may include rubber scraping element which scrapes applied cleaning fluid from a window. An optional force sensor may be included to dynamically maintain the appropriate level of force on the surface to be cleaned regardless of the irregularity of that surface. The force sensor can be positioned within adapter 504 or elsewhere within the robot arm. The force sensor provides at least one degree of freedom of force sensing capability that detects the force experienced by the blade 503. The cleaning fluid dispensing system 505 is mounted at the adaptor and positioned to distribute cleaning fluid onto the cleaning surface adjacent to the rubber blade 503. The cleaning fluid dispensing system 505 is fed by a pump associated with platform reservoir 202 or, alternatively, fed by a pump associated with rooftop unit 103.

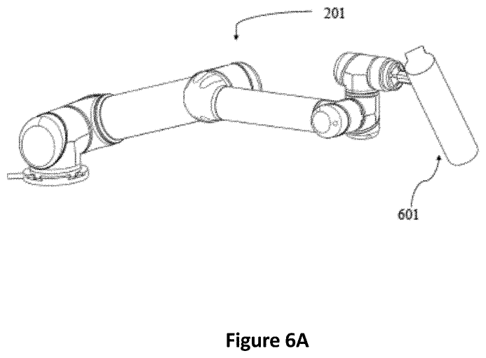

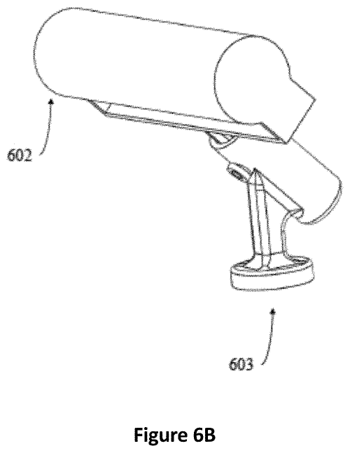

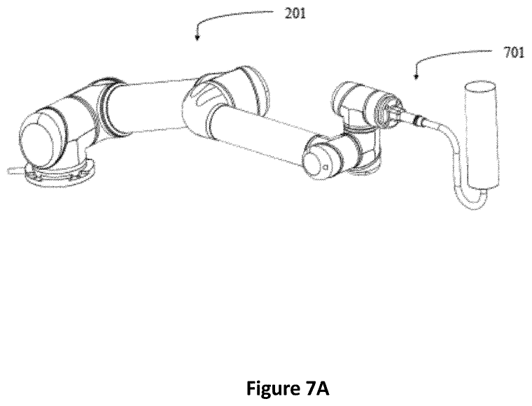

When cleaning fluid is applied to a window surface, the fluid may splash and quickly flow downward, away from the target region. A robot arm equipped with a sponge may be used to collect excess cleaning solution as the robot arm with the wiper performs the cleaning task. Both arms may collaborate in the cleaning activity, maximizing the cleaning effect and avoiding streaks from dripping cleaning fluid. FIG. 6 illustrates a robot arm equipped with a sponge roller for cooperating with the robot arm of FIGS. 5A-5B. In FIG. 6A, a sponge roller 601 is mounted at the distal end a second robot arm 201. The cleaning fluid-absorbing sponge 601 is specially designed for the dual cable robot system, as shown in FIG. 6B, it includes two major portions: the cleaning fluid-absorbing roller 602 and the sponge-robot arm adaptor 603. The robot arm 201 drives the roller 602 to absorb excess cleaning fluid in cooperation with the wiper blade-holding robot arm. As with the wiper blade-holding robot, a force sensor may be included in the adapter 603 or elsewhere on the robot arm itself. The force sensor provides at least one degree of freedom which detects the force experienced by the sponge 602 when in contact with building façade. When desiring to maintain a set level of force, the robot arms will adjust their length and pressure when there is a protrusion or building curvature in the path of the cleaning tool.

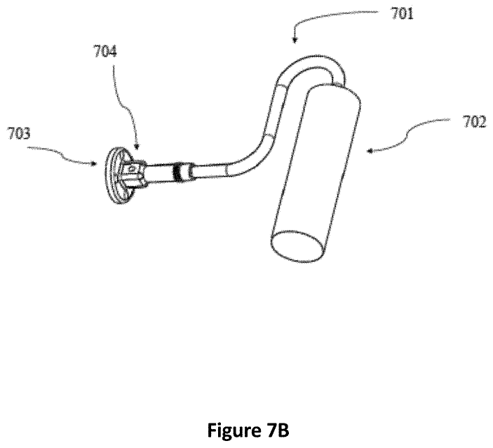

Façade painting can be carried out with the paint roller system 701 as shown in FIG. 7A. The painting system is specifically designed for the dual cable robot system of the present invention. The roller used can be refilled continuously using a special type of roller and paint pumping system. A paint roller 701 system is mounted on the distal end of robot arm 201. As seen in FIG. 7B, it includes 3 major components: a continuous paint roller 702, a roller/robot arm adaptor 703 and paint-feeding system 704. The robot arm 201 drives the paint roller 702 to apply paint over the façade surface. A force sensor can be included in adapter 703 or within the robot arm 201. The force sensor provides a at least one degree of freedom which detects the force experienced by the roller 702 when in contact with building façade. Paint can be supplied into the paint roller from input system 704 by a pump associated with platform reservoir 202 or, alternatively, from a reservoir in unit 103 positioned on the roof.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

1. A robot system for maintenance of a building façade with an irregular façade surface comprising:
a platform cooperating with a least four pairs of cables for positioning the platform at a distance from a building façade;
at least one robot arm situated on the platform, the at least one robot arm including an adaptor positioned at a distal end thereof for holding and manipulating a building façade maintenance tool;
an actuator for driving the at least four pairs of cables to move the platform to any arbitrary position along the building façade;
a controller cooperating with the actuator for instructing the actuator to drive the at least four pairs of cables and for controlling movement of the at least one robot arm, wherein driving the actuator and movement of the robot arm is coordinated by the controller such that any position deviations in the platform are compensated for by positioning or movement of the robot arm.

2. The robot system of claim 1, wherein two pairs of cables are positioned between the platform and a building roof and two pairs of cables are positioned between the platform and a ground location.

3. The robot system of claim 1, further comprising a reservoir positioned on the platform.

4. The robot system of claim 1, further comprising a tool changer positioned on the platform.

5. The robot system of claim 1, further comprising a tool changer positioned on the building's roof.

6. The robot system of claim 1, further comprising a cable routing suspension system for positioned the platform at a distance from the building façade.

7. The robot system of claim 1, further comprising one or more sensors positioned on one or more of the platform and the robot arm to provide feedback to the controller.

8. The robot system of claim 7, wherein the one or more sensors are selected from pressure sensors, machine vision sensors, cameras, or position sensors.

9. The robot system of claim 1, wherein the tool is selected from one or more of a window cleaning wiper, a sponge roller, or a paint roller.

10. The robot system of claim 1, further comprising one or more pulleys positioned on the platform to route the cables.
